(19) United States
(12) Patent Application Publication
(10) Pub. No.: US 2009/0212686 A1
(43) Pub. Date: Aug. 27, 2009

(54) INORGANIC EL BLUE-LIGHT EMITTING BODY, METHOD FOR MANUFACTURING THE SAME, AND LIGHT EMITTING DEVICE

(75) Inventors: Shunichi ITO, Atsugi (JP); Junichiro SAKATA, Atsugi (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 12/370,770

(22) Filed: Feb. 13, 2009

(30) Foreign Application Priority Data
Feb. 21, 2008 (JP) 2008-039823

(51) Int. Cl. H01J 1/62; C09K 11/56

(52) U.S. Cl. 313/503; 252/301.6 S; 252/301.4 S

(57) ABSTRACT

In manufacturing of an inorganic EL blue-light emitting body, at least a sulfide light emitting body and a rare-earth copper oxychaleogenide (MCuOS, wherein M is a rare-earth metal) are mixed and the obtained mixture is baked at 600° C. or more and 1000° C. or less, whereby the sulfide light emitting body can include the rare-earth copper oxychalcogenide (MCuOS).

### BACKGROUND OF THE INVENTION

1. Field of the Invention

The present invention relates to a method for manufacturing an inorganic EL blue-light emitting body (a light emitting body is also referred to as a phosphor), and a light emitting device using the inorganic EL blue-light emitting body.

2. Description of the Related Art

Development of electroluminescence (EL) has been undertaken for application for surface light sources (backlights) and image display devices (displays). Many structures of EL materials and EL elements have been studied.

EL elements are broadly classified into inorganic EL elements and organic EL elements. Organic EL elements are generally formed using organic EL materials and driven by direct current. Inorganic EL elements are generally formed using inorganic EL materials and driven by alternating current.

As an inorganic EL material which is used for an inorganic EL element, a light emitting body containing BaAl₂S₄, which exhibits blue-light emission, is known. This light emitting body is a light emitting body BaAl₂S₄:Eu which is obtained by adding europium (Eu) serving as an emission center to a base material represented by BaAl₂S₄ (for example, see Non-Patent Document 1: Noboru Miura et al., J. Appl. Phys., Vol. 38, L1291-L1292 (1999)).

There are other known light emitting bodies containing ZnS (for example, see Patent Document 1: Japanese Published Patent Application No. H07-157759). Among light emitting bodies containing ZnS, a light emitting body (ZnS:Cu) obtained by adding copper (Cu), as is known, emits bluish-green light with a broad light emission peak in a wavelength region of 450 nm to 550 nm.

Further, it is known that light emission from a light emitting body (ZnS:Ag) which is obtained by adding silver (Ag) to ZnS (for example, see Non-Patent Document 2: Su-Hua Yang and Meiso Yokoyama., J. Appl. Phys., Vol. 41, L5609-L5613 (2002)) is blue light emission with a shorter wave length and a sharper light emission peak than light emission from the light emitting body (ZnS:Cu) which is obtained by adding copper (Cu).

Therefore, the light emitting body (ZnS:Ag) which is obtained by adding silver (Ag) appears to be a highly promising material for inorganic EL elements because of its excellent color purity. However, the light emitting body (ZnS:Ag) which is obtained by adding silver (Ag) emits intense light by ultraviolet ray excitation or electron beam excitation, but hardly emits light by electric field excitation. Accordingly, the light emitting body (ZnS:Ag) cannot be used as a blue-light emitting body for an inorganic EL element in the present state.

### SUMMARY OF THE INVENTION

It is an object to manufacture a light emitting body which exhibits blue light emission (a blue-light emitting body) by electric field excitation, that is, to manufacture a blue-light emitting body which is applicable to an inorganic EL element, and to reduce effects of emission luminance change of the blue-light emitting body on the chromaticity coordinates of the light it emits. Further, it is another object to improve the repeatability of images displayed on a light emitting device including the inorganic EL element and to realize stable display with the light emitting device which is hardly affected by luminance change.

According to a method for manufacturing an inorganic EL blue-light emitting body which is one aspect of the present invention, at least a sulfide light emitting body and a rare-earth copper oxychalcogenide (MCuOS, wherein M is a rare-earth metal) are mixed to obtain a mixture and the obtained mixture is baked at 600° C. or more and 1000° C. or less, whereby the sulfide light emitting body can contain the rare-earth copper oxychalcogenide (MCuOS).

In addition, the present invention also covers a structure in which, in the foregoing structure, an additive is added to the sulfide light emitting body and the rare-earth copper oxychalcogenide (MCuOS, wherein M is a rare-earth metal) and mixed.

In the foregoing structure, the sulfide light emitting body is any one of ZnS:Ag,Cl, ZnS:Au,Cl, CdS:Ag,Cl, CdS:Au,Cl, CaS:Ag,Cl, or CaS:Au,Cl.

In the foregoing structure, the additive is metal oxide which is soluble in an acid solution. In specific, the additive is any one of zinc oxide (ZnO), magnesium oxide (MgO), or lanthanum oxide (La₂O₃).

In the foregoing structure, the rare-earth copper oxychalcogenide (MCuOS) is any one of a lanthanum copper oxychalcogenide (LaCuOS), a cerium copper oxychalcogenide (CeCuOS), a scandium copper oxychalcogenide (SeCuOS), or an yttrium copper oxychalcogenide (YCuOS).

Among the foregoing structures, in the case of adding the additive, the concentration of the additive which is added is 0.1 wt % or more and 20 wt % or less with respect to the sulfide light emitting body.

In the foregoing structure, the concentration of the rare-earth copper oxychalcogenide (MCuOS) which is added is 1 wt % or more and 5 wt % or less with respect to the sulfide light emitting body.

Another aspect of the present invention is an inorganic EL blue-light emitting body which is a sulfide light emitting body represented by a formula ZnS:Ag,Cl containing a rare-earth copper oxychalcogenide (MCuOS, wherein M is a rare-earth metal).

Note that the sulfide light emitting body in the foregoing structure has an emission peak in the region between a wavelength of 400 nm or more and 500 nm or less.

Another aspect of the present invention is a light emitting element including an inorganic EL layer between a pair of electrodes, in which the inorganic EL layer includes the above-described inorganic EL blue-light emitting body.

Note that the present invention also covers a structure of a light emitting element which includes at least a dielectric layer between one of the pair of electrodes and the inorganic EL layer, in addition to the foregoing structure.

Further, another aspect of the present invention is a light emitting device which is formed by using the above-described light emitting element.

Note that the present invention covers not only a light emitting device including an inorganic EL element, but an electronic device including the light emitting device. Accordingly, a light emitting device in this specification refers to an image display device, a light emitting device, or a light source (including an illuminating device). Further, the light emitting device also includes any of the following modules in its category: a module to which a connector such as an flexible printed circuit (FPC), a tape automated bonding (TAB) tape, or a tape carrier package (TCP) is attached to a light emitting device; a module having a TAB tape or a TCP which is provided with a printed wiring board at the end thereof; and a module having an integrated circuit (IC) which is directly mounted on an inorganic EL element by a chip on glass (COG) method.

An inorganic EL blue-light emitting body of which change in chromaticity coordinates due to emission luminance change is small can be provided. Therefore, compared to a conventional light emitting device, a light emitting device which can stably display images with favorable repeatability without being affected by luminance can be provided by applying an inorganic EL element which is formed by using the above-described inorganic EL blue-light emitting body to a light emitting device or the like.

### BRIEF DESCRIPTION OF THE DRAWINGS

FIGS. 1A and 1B illustrate an inorganic EL blue-light emitting body.

FIGS. 2A to 2C illustrate an inorganic EL element.

FIGS. 3A to 3C illustrate passive matrix light emitting devices.

FIG. 4 illustrates a passive-matrix light emitting device.

FIG. 5 illustrates a passive-matrix light emitting device.

FIGS. 6A to 6E illustrate electronic devices.

FIGS. 7A to 7C illustrate an electronic device.

FIG. 8 is a graph showing frequency-luminance characteristics of an inorganic EL element.

FIG. 9 is a graph showing voltage-luminance characteristics of an inorganic EL element.

FIG. 10 is a graph showing emission luminance-chromaticity coordinates (the x-coordinate and the y-coordinate) characteristics of an inorganic EL element.

### DETAILED DESCRIPTION OF THE INVENTION

Hereinafter, embodiment modes and an embodiment of the present invention will be described in detail with reference to the drawings. Note that the present invention is not limited to the description given below, and modes and details of the present invention can be modified in various ways without departing from the spirit and scope of the present invention. Accordingly, the present invention should not be construed as being limited to the description of the embodiment modes and the embodiment given below.

### Embodiment Mode 1

In this embodiment mode, a synthesis method of an inorganic EL blue-light emitting body which is one aspect of the present invention is described.

Note that an inorganic EL blue-light emitting body described in this embodiment mode is a sulfide light emitting body containing a rare-earth copper oxychalcogenide (MCuOS). A solid-phase method can be employed as a synthesis method of the rare-earth copper oxychalcogenide (MCuOS).

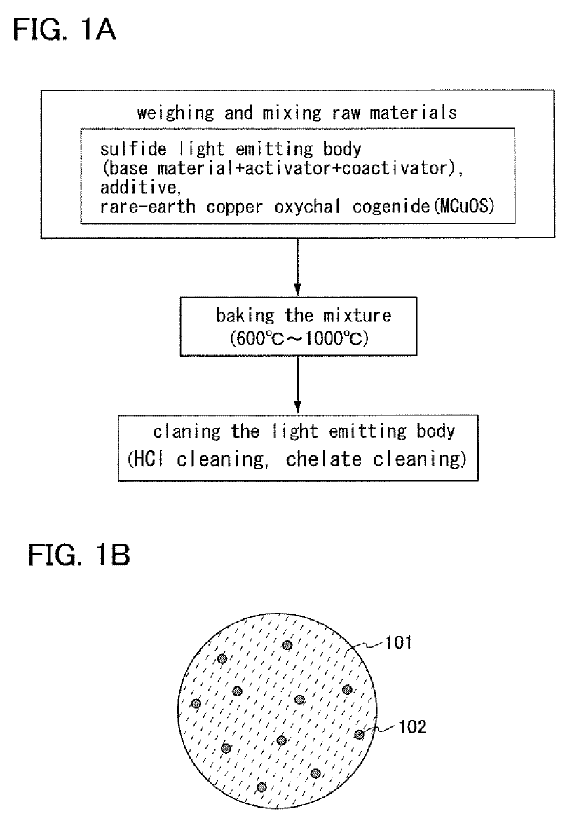

In the case of employing a solid-phase method, as illustrated in a flow chart of FIG. 1A, a sulfide light emitting body, an additive, and a rare-earth copper oxychalcogenide (MCuOS), which are raw materials, are weighed and mixed, then, baked at 600° C. or more and 1000° C. or less, preferably at 700° C. or more and 800° C. or less and cleaned to form a sulfide light emitting body containing a rare-earth copper oxychalcogenide (MCuOS).

A sulfide light emitting body which is a raw material contains a base material, an activator, and a coactivator. Note that the base material is a sulfide and for example, zinc sulfide (ZnS), cadmium sulfide (CdS), calcium sulfide (CaS), yttrium sulfide (Y₂S₃), gallium sulfide (Ga₂S₃), strontium sulfide (SrS), or barium sulfide (BaS) can be used. Alternatively, a ternary mixed crystal such as calcium sulfide-gallium (CaGa₂S₄), strontium sulfide-gallium (SrGa₂S₄), or barium sulfide-gallium (BaGa₂S₄), can be used.

As the activator, for example, gold (Au), silver (Ag), or copper (Cu) can be used. Note that the concentration of the activator which is mixed is in the range of 0.01 wt % to 10 wt %, preferably 0.1 wt % to 1 wt % with respect to the base material.

As the coactivator, for example, a halogen element such as fluorine (F), chlorine (Cl), bromine (Br), iodine (I), or astatine (At) or aluminium (Al) or the like can be used. Alternatively, a compound containing a transition metal, or a rare-earth metal, and a halogen element can be used. Note that the concentration of the coactivator which is mixed is in the range of 0.01 wt % to 10 wt %, preferably 0.1 wt % to 1 wt % with respect to the base material.

Accordingly, as the sulfide light emitting body which is a raw material, for example, ZnS:Ag,Cl, ZnS:Au,Cl, ZnS:Cu,Cl, CdS:Ag,Cl, CdS:Au,Cl, CdS:Cu,Cl, CaS:Ag,Cl, CaS:Au,Cl, or CaS:Cu,Cl can be used. Note that as the sulfide light emitting body which is used in this embodiment mode, a commercially available sulfide light emitting body containing the above described base material, activator, and coactivator can alternatively be used. Further, the grain diameter of a sulfide light emitting body used in this embodiment mode is preferably 5 μm to 30 μm.

Further, as a rare-earth copper oxychalcogenide (MCuOS, wherein M is a rare-earth metal), for example, a lanthanum copper oxychalcogenide (LaCuOS), a cerium copper oxychalcogenide (CeCuOS), a scandium copper oxychalcogenide (ScCuOS), a yttrium copper oxychalcogenide (YCuOS), or the like can be used. Note that the concentration of the rare-earth copper oxychalcogenide (MCuOS) which is added is in the range of 1 wt % to 5 wt % with respect to the sulfide light emitting body.

Further, an additive can be added to the above-described sulfide light emitting body. As the additive, metal oxide which is soluble in an acid solution can be used. For example, zinc oxide (ZnO), magnesium oxide (MgO), lanthanum oxide (La₂O₃), or the like can be used. Note that the concentration of the additive which is added is in the range of 0.1 wt % to 20 wt % with respect to the sulfide light emitting body.

A powder which is obtained after baking is a sulfide light emitting body containing a rare-earth copper oxychalcogenide (MCuOS) which is an inorganic EL blue-light emitting body. As illustrated in FIG. 1B, the sulfide light emitting body 101 contains a rare-earth copper oxychalcogenide (MCuOS) 102. Then, by cleaning the sulfide light emitting body containing a rare-earth copper oxychalcogenide, impurities which are attached to a surface of the sulfide light emitting body can be removed. Thus, the sulfide light emitting body with high purity can be obtained. Note that as a cleaning method employed here, acetic acid (CH₃COOH) cleaning, hydrochloric acid (HCl) cleaning, chelate cleaning, and the like can be given.

Note that, as a sulfide light emitting body containing a rare-earth copper oxychalcogenide (MCuOS), any of the following examples can be employed: ZnS:Ag,Cl+MCuOS, ZnS:Au,Cl+MCuOS, ZnS:Cu,Cl+MCuOS, CdS:Ag,Cl+MCuOS, CdS:Au,Cl+MCuOS, CdS:Cu,Cl+MCuOS, CaS:Ag,Cl+MCuOS, CaS:Au,Cl+MCuOS, or CaS:Cu,Cl+MCuOS. Note that in this specification, a sulfide light emitting body containing a rare-earth copper oxychalcogenide (MCuOS) is represented by “a formula of a sulfide light emitting body+MCuOS” as given above.

Although the above-described solid-phase method requires baking at a relatively high temperature compared to other methods, the solid-phase method is a simple method, and therefore has high productivity and is suitable for mass production.

As described thus far, a sulfide light emitting body containing a rare-earth copper oxychalcogenide (MCuOS) which is an inorganic EL blue-light emitting body can be formed. Note that a sulfide light emitting body containing a rare-earth copper oxychalcogenide (MCuOS) has an emission peak at a wavelength region of 400 nm or more and 500 nm or less and has higher color purity of blue of which change due to luminance change is smaller than a conventionally known inorganic EL blue-light emitting body. Therefore, compared with a conventional light emitting device, a light emitting device which can stably display images with favorable repeatability without being affected by luminance change can be provided by applying the sulfide light emitting body containing a rare-earth copper oxychalcogenide (MCuOS) to a light emitting device or the like.

### Embodiment Mode 2

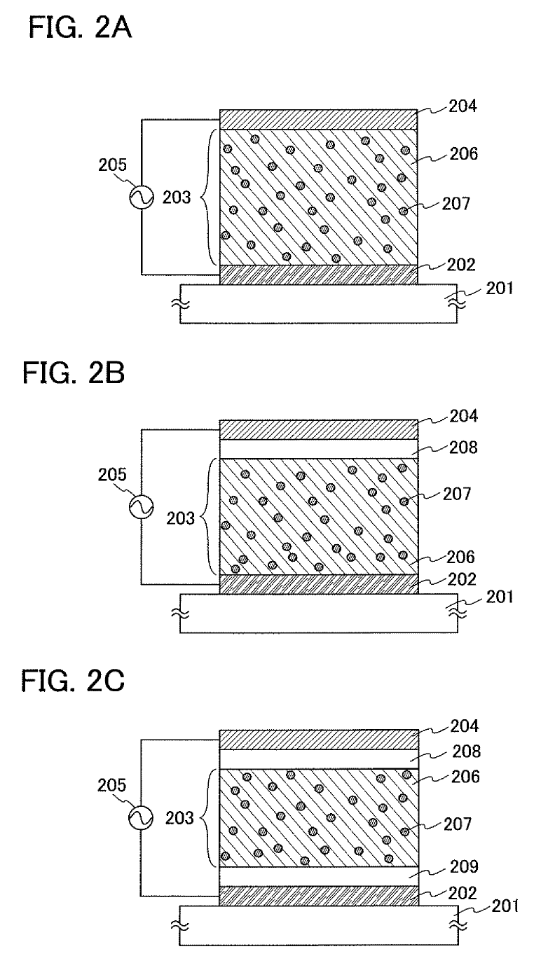

In this embodiment mode, a dispersion type inorganic EL element formed using an inorganic EL blue-light emitting body of one aspect of the present invention is described with reference to FIGS. 2A to 2C.

In an inorganic EL element described in this embodiment mode, a first electrode 202, an inorganic EL layer 203, and a second electrode 204 are stacked in that order over the substrate 201. Note that a dielectric layer serving as a dielectric can be provided between the first electrode 202 and the inorganic EL layer 203 and/or between the inorganic EL layer 203 and the second electrode 204.

Then, when a predetermined voltage is applied between the first electrode 202 and the second electrode 204, the inorganic EL layer 203 emits light. Note that the inorganic EL element described here is an alternating current driving element driven by AC voltage applied between the two electrodes by an AC power source 205.

As the substrate 201 in FIGS. 2A to 2C, a substrate having an insulating surface or an insulating substrate is employed. Specific examples of the substrate include various types of glass substrates that are used in the electronics industry, such as an aluminosilicate glass substrate, an aluminoborosilicate glass substrate, or a barium borosilicate glass substrate; a quartz substrate; a ceramic substrate; and a sapphire substrate.

For the first electrode 202 and the second electrode 204, any of various types of metals, alloys, electrically conductive compounds, mixtures thereof or the like can be used. Specific examples are given below: indium tin oxide (ITO), indium tin oxide containing silicon or silicon oxide, indium zinc oxide (IZO), and indium oxide containing tungsten oxide and zinc oxide. In addition, gold (Au), platinum (Pt), nickel (Ni), tungsten (W), chromium (Cr), molybdenum (Mo), titanium (Ti), iron (Fe), cobalt (Co), copper (Cu), palladium (Pd), aluminium (Al), silver (Ag), lithium (Li), cesium (Cs), magnesium (Mg), calcium (Ca), strontium (Sr), europium (Eu), ytterbium (Yb), an alloy and nitride containing any of those metals (for example, titanium nitride), and the like can be given.

A film of any of those materials is generally formed by a sputtering method. For example, a film of indium zinc oxide can be formed by a sputtering method using a target in which zinc oxide is added to indium oxide at 1 wt % to 20 wt %. A film of indium oxide containing tungsten oxide and zinc oxide can be formed by a sputtering method using a target in which tungsten oxide and zinc oxide are added to indium oxide at 0.5 wt % to 5 wt % and 0.1 wt % to 1 wt %, respectively. Alternatively, a vacuum evaporation method can be employed. Further, the film may be formed by an ink-jet method, a spin coating method, or the like by application of a sol-gel process or the like.

The first electrode 202 and the second electrode 204 are not limited to a single-layer film and can be formed as a stacked-layer film. Note that in order to extract light emitted by the inorganic EL layer 203 to outside, one or both of the first electrode 202 and the second electrode 204 are formed so as to transmit light. For example, one or both of the first electrode 202 and the second electrode 204 are formed using a conductive material having a light-transmitting property, such as ITO, or formed using silver, aluminum, or the like with a thickness of several nanometers to several tens of nanometers. Alternatively, a stacked-layer structure including a thin film of a metal such as silver, aluminum, or the like with a reduced thickness and a thin film of a conductive material having a light-transmitting property, such as ITO, can be employed.

The inorganic EL layer 203 is formed between the first electrode 202 and the second electrode 204. In the inorganic EL layer 203, particles of a sulfide light emitting body containing a rare-earth copper oxychalcogenide (MCuOS) 207 which is an inorganic EL blue-light emitting body described in Embodiment Mode 1 are dispersed in a binder 206. Note that as a sulfide light emitting body containing a rare-earth copper oxychalcogenide (MCuOS), any of the following examples can be employed: ZnS:Ag,Cl+MCuOS, ZnS:Au,Cl+MCuOS, ZnS:Cu,Cl+MCuOS, CdS:Ag,Cl+MCuOS, CdS:Au,Cl+MCuOS, CdS:Cu,Cl+MCuOS, CaS:Ag,Cl+MCuOS, CaS:Au,Cl+MCuOS, or CaS:Cu,Cl+MCuOS. Note that in formation of the inorganic EL layer 203, the foregoing sulfide light emitting body containing a rare-earth copper oxychalcogenide (MCuOS) and another known material (for example, a material with a different emission color) can be used in combination.

The binder used in the inorganic EL layer 203 is a substance for fixing particles of an inorganic EL blue-light emitting body in a dispersed state in the inorganic EL layer 203. In specific, an organic insulating material or an inorganic insulating material can be used. Further, a mixed material of an organic insulating material and an inorganic insulating material can be used.

As the organic insulating material which is used as the binder, a polymer with a relatively high dielectric constant such as a cyanoethyl cellulose-based resin, or a resin such as polyethylene, polypropylene, a polystyrene-based resin, a silicone resin, an epoxy resin, or a vinylidene fluoride resin can be used. Alternatively, a heat-resistant high molecule such as aromatic polyamide or polybenzoimidazole, or a siloxane resin can be used. Note that a siloxane resin corresponds to a resin including a Si—O—Si bond. Siloxane is composed of a skeleton formed by the bond of silicon (Si) and oxygen (O), in which an organic group containing at least hydrogen (such as an alkyl group and aromatic hydrocarbon) is used as a substituent. A fluoro group may be included in the organic group. Further, a vinyl resin such as polyvinyl alcohol or polyvinyl butyral, or a resin such as a phenol resin, a novolac resin, an acrylic resin, a melamine resin, a urethane resin, an oxazole resin (a polybenzoxazole resin) may be used as the organic insulating material. Microparticles having a high dielectric constant such as barium titanate (BaTiO₃) or strontium titanate (SrTiO₃) can also be mixed to these resins as appropriate to adjust a dielectric constant.

As the inorganic insulating material which is used as the binder, any materials selected from the following materials can be used: silicon oxide, silicon nitride, silicon containing oxygen and nitrogen, aluminum nitride, aluminum containing oxygen and nitrogen, aluminum oxide, titanium oxide, barium titanate, strontium titanate, lead titanate, potassium niobate, lead niobate, tantalum oxide, barium tantalate, lithium tantalate, yttrium oxide, zirconium oxide, zinc sulfide, or other substances containing an inorganic insulating material. Note that by mixing (by adding) the organic insulating material with an inorganic insulating material having a high dielectric constant, the dielectric constant of the inorganic EL layer including an inorganic EL blue-light emitting body and a binder can be adjusted, e.g., increased.

The inorganic EL layer 203 in this embodiment mode is formed by using a solution containing the inorganic EL blue-light emitting body described in Embodiment Mode 1 and a binder by a droplet discharge method, a printing method (such as screen printing or offset printing), a coating method such as a spin coating method, a dipping method, a dispenser method, or the like. Accordingly, as a solvent for forming the solution containing the inorganic EL blue-light emitting body and a binder, a solvent which dissolves a material which is a binder and a solvent whose viscosity can be controlled to be suitable for manufacturing and controlling the film thickness of the inorganic EL layer (various kinds of wet processes) may be selected as appropriate. For example, in the case of using a siloxane resin as a binder, an organic solvent such as propylene glycolmonomethyl ether, propylene glycolmonomethyl ether acetate (also referred to as PGMEA), 3-methoxy-3-methyl-l-butanol (also referred to as MMB), or the like can be used as the solvent.

Note that the thickness of the inorganic EL layer 203 is preferably in the range of 10 nm to 1000 nm. Further, an inorganic EL blue-light emitting body may be contained in the inorganic EL layer 203 at 50 wt % or more and 80 wt % or less.

Further, the inorganic EL element in this embodiment mode may have a structure in which a dielectric layer is provided between an electrode (the first electrode 202 and/or the second electrode 204) and the inorganic EL layer 203 as illustrated in FIG. 2B or FIG. 2C. Note that FIG. 2B has a structure (a one-side structure) in which the dielectric layer 208 is formed between the second electrode 204 and the inorganic EL layer 203, and FIG. 2C has a structure (a two-side structure) in which a dielectric layer 209 is formed between the first electrode 202 and the inorganic EL layer 203 in addition to the structure in FIG. 2B. As for the one-side structure in FIG. 2B, the dielectric layer 208 may be formed between the first electrode 202 and the inorganic EL layer 203.

Note that that the dielectric layers (208 and 209) preferably are dense films having high dielectric strength voltage and high dielectric constant. For example, an insulating material such as silicon oxide, yttrium oxide, titanium oxide, aluminum oxide, hafnium oxide, tantalum oxide, barium titanate, strontium titanate, lead titanate, silicon nitride, or zirconium oxide can be used. Further, a mixed film of any of those materials or a stacked-layer film of two or more kinds of those materials can be used. As a manufacturing method of the dielectric layer, a sputtering method, a vacuum evaporation method, a CVD method, or the like can be employed. Alternatively, the dielectric layer can be formed by dispersing particles of any of those insulating materials in a binder. Note that as a material of the binder, a material similar to a material of the binder of the above-described inorganic EL layer can be used. In addition, the thickness of the dielectric layer is preferably in the range of 10 nm to 1000 nm.

As described thus far, an inorganic EL element can be formed in which the sulfide light emitting body containing a rare-earth copper oxychalcogenide (MCuOS) which is an inorganic EL blue-light emitting body is used for an inorganic EL layer. Note that a sulfide light emitting body containing a rare-earth copper oxychalcogenide (MCuOS) has higher color purity of blue of which change due to luminance change is smaller than a conventionally known inorganic EL blue-light emitting body. Therefore, an inorganic EL element which is formed by using the sulfide light emitting body can also have high color purity of blue of which change due to luminance change is small.

### Embodiment Mode 3

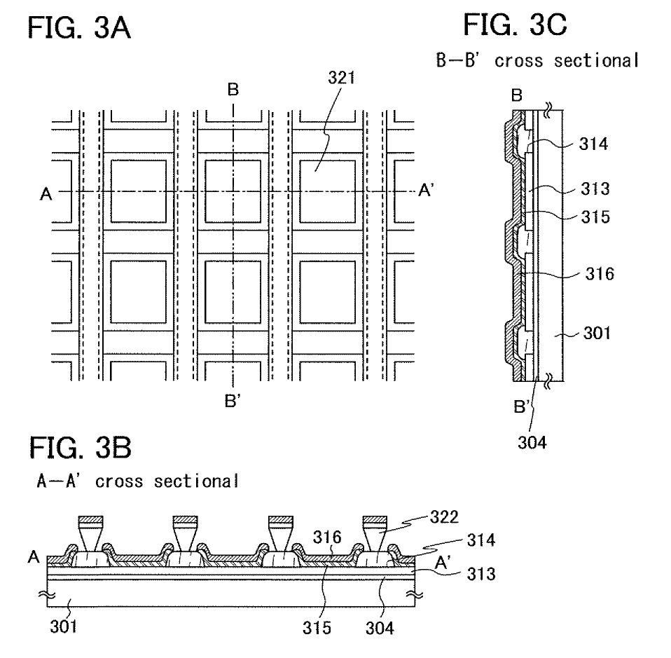

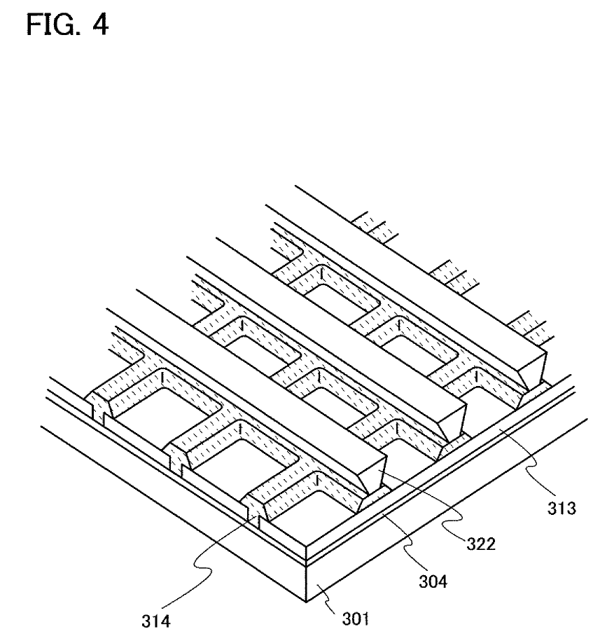

In this Embodiment Mode 3, as a light emitting device which is formed using the inorganic EL element of one aspect of the present invention, a passive-matrix light emitting device is described with reference to FIGS. 3A to 3C and FIG. 4.

In a passive-matrix (also called simple-matrix) light emitting device, a plurality of anodes arranged in stripes (in stripe form) are provided to be perpendicular to a plurality of cathodes arranged in stripes. A light emitting layer is sandwiched at intersections of the anodes and the cathodes. Therefore, a pixel at an intersection of an anode selected (to which voltage is applied) and a cathode selected emits light.

FIG. 3A is a top view of a pixel portion before sealing. FIG. 3B is a cross-sectional view taken along dashed line A-A′ in FIG. 3A. FIG. 3C is a cross-sectional view taken along dashed line B-B′ in FIG. 3A.

Over a substrate 301, an insulating layer 304 is formed as a base insulating layer. Note that the insulating layer 304 is not necessarily formed if the base insulating layer is not needed. A plurality of first electrodes 313 are arranged in stripes at regular intervals over the insulating layer 304. A partition wall 314 having openings each corresponding to a pixel is provided over the first electrodes 313. The partition wall 314 having openings is formed using an insulating material (a photosensitive or nonphotosensitive organic material (polyimide, acrylic, polyamide, polyimide amide, resist, or benzocyclobutene) or an SOG film (such as a SiOₓ film including an alkyl group)). Note that each opening corresponding to a pixel serves as a light emitting region 321.

Over the partition wall 314 having openings, a plurality of inversely tapered partition walls 322 which are parallel to one another are provided to intersect with the first electrodes 313. The inversely tapered partition walls 322 are formed by a photolithography method using a positive-type photosensitive resin, of which a portion unexposed to light remains as a pattern. In formation of the inversely tapered partition walls 322, the amount of light or the length of development time are adjusted so that a lower portion of the pattern is etched more.

FIG. 4 is a perspective view after formation of the plurality of inversely tapered partition walls 322 which are parallel to one another. Note that the same reference numerals are used to denote the same portions as those in FIGS. 3A to 3C.

The total thickness of the partition wall 314 having openings and the inversely tapered partition wall 322 is set to be larger than the thickness of a stacked-layer film including films forming an inorganic EL layer and a second electrode. Thus, an inorganic EL layer 315 and a second electrode 316 which are divided into a plurality of regions are formed. Note that the plurality of regions are electrically isolated from one another.

The second electrodes 316 are electrodes in stripes which are parallel to one another and extended in a direction intersecting with the first electrodes 313. Note that a part of a film forming the inorganic EL layer 315 and a part of a film forming the second electrode 316 are also formed over the inversely tapered partition walls 322; however, they are separated from the inorganic EL layer 315, and the second electrode 316. Note that the inorganic EL layer in this embodiment mode is a layer including at least the inorganic EL blue-light emitting body which is manufactured in Embodiment Mode 1. For example, particles of the inorganic EL blue-light emitting body are dispersed in a binder Note that the inorganic EL layer 315 may include a dielectric layer formed of a dielectric substance or any functional layer for improving light emission efficiency of the light emitting body.

The light emitting device may be a monochromatic light emitting device which emits light of the same color from the entire surface. Alternatively, by appropriate provision of a color conversion layer, the light emitting device may be a light emitting device capable of RGB color (or RGBW color) display, or a light emitting device capable of area color display. Here, the inorganic EL layer 315 is separated into a plurality of regions by the partition wall 314 and the partition wall 322. Thus, by arranging color conversion layers which can convert the color of light into red, green, and blue in accordance with the separated regions, a light emitting device which performs RGB color display can be obtained. Note that the color conversion layer may be provided between the light emitting layer and a substrate through which light is extracted.

Further, sealing is performed using a sealant such as a sealant can or a glass substrate for sealing, if necessary. Here, a glass substrate is used as a sealing substrate, and the substrate 301 and the sealing substrate are attached to each other with an adhesive material such as a sealant to seal a space surrounded by the adhesive material such as a sealant. The space that is sealed is filled with a filler or a dried inert gas. In addition, a desiccant or the like may be put between the substrate and the sealing material to increase the reliability of the light emitting device. The desiccant removes a minute amount of moisture for sufficient desiccation. As the desiccant, a substance that adsorbs moisture by chemical adsorption such as oxide of an alkaline earth metal like calcium oxide or barium oxide can be used. Alternatively, a substance that adsorbs moisture by physical adsorption such as zeolite or silicagel may be used. Note that if the sealant that covers and is contact with the light emitting element is provided and sufficiently blocks the outside air, the desiccant agent is not necessarily provided.

FIG. S is a top view of the case in which an FPC or the like is mounted on the passive-matrix light emitting device in FIGS. 3A to 3C.

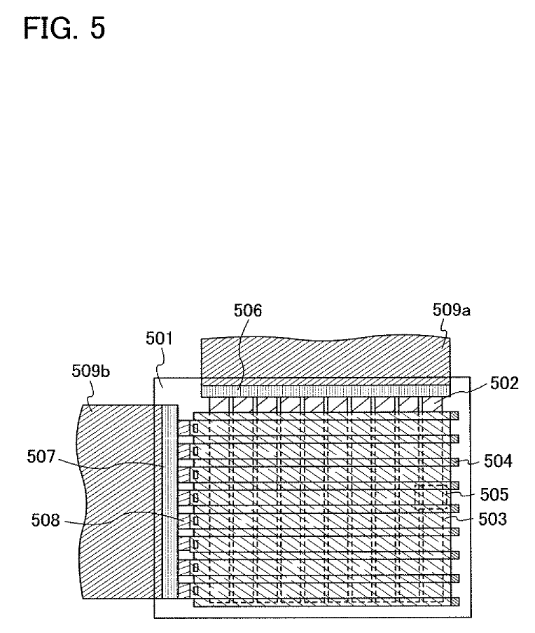

In FIG. 5, scan lines and data lines intersect with each other perpendicularly in a pixel portion for displaying images. Here, the first electrode 313 in FIGS. 3A to 3C corresponds to a scan line 503 in FIG. 5; the second electrode 316 in FIGS. 3A to 3C corresponds to a data line 502 in FIG. 5; and the inversely tapered partition wall 322 corresponds to a partition wall 504. An EL layer is sandwiched between the data line 502 and the scan line 503, and an intersection portion indicated by a region 505 corresponds to one pixel.

Note that the scan line 503 is electrically connected at the end to a connection wiring 508, and the connection wiring 508 is connected to an FPC 509b through an input terminal 507. In addition, the data line 502 is connected to an FPC 509a through an input terminal 506.

If necessary, a polarizing plates a circularly polarizing plate (an elliptically polarizing plate), a retardation plate (a quarter-wave plate or a half-wave plate), or an optical film such as a color filter may be provided as appropriate over a light emitting surface. Further, the polarizing plate or the circularly polarizing plate may be provided with an anti-reflection film. For example, anti-glare treatment can be carried out by which reflected light can be diffused by surface roughness so as to reduce glare.

Although FIG. 5 illustrates an example in which a driver circuit is not provided over the substrate, the present invention is not particularly limited thereto. An IC chip including a driver circuit may be mounted on the substrate.

In the case where an IC chip is mounted, a data line side IC and a scan line side IC, in each of which a driver circuit for transmitting a signal to the pixel portion is formed, are mounted on the periphery of (outside) the pixel portion by a COG method. The mounting may be performed using a TCP or a wire bonding method other than a COG method. A TCP is a TAB tape mounted with an IC, and the TAB tape is connected to a wiring over an element-forming substrate for mounting the IC. Each of the data line side IC and the scan line side IC may be formed using a silicon substrate or may include a driver circuit formed using TFTs over a glass substrate, a quartz substrate, or a plastic substrate. Although described here is an example in which a single IC is provided on one side, a plurality of ICs may be provided on one side.

The thus formed passive-matrix light emitting device can include an inorganic EL element in which a sulfide light emitting body containing a rare-earth copper oxychalcogenide (MCuOS) which is the inorganic EL blue-light emitting body manufactured by one aspect of the present invention is used for an inorganic EL layer. Note that a sulfide light emitting body containing a rare-earth copper oxychalcogenide (MCuOS) has higher color purity of blue of which change due to luminance change is smaller than a conventionally known inorganic EL blue-light emitting body. Therefore, compared with a conventional light emitting device, a light emitting device which can stably display images with favorable repeatability without being affected by luminance change can be formed by using the light emitting body.

Note that the structure in Embodiment Mode 3 can be combined with the structure in Embodiment Mode 1 or 2 as appropriate.

### Embodiment Mode 4

In this embodiment mode, various electronic devices completed using the light emitting device of one aspect of the present invention is described.

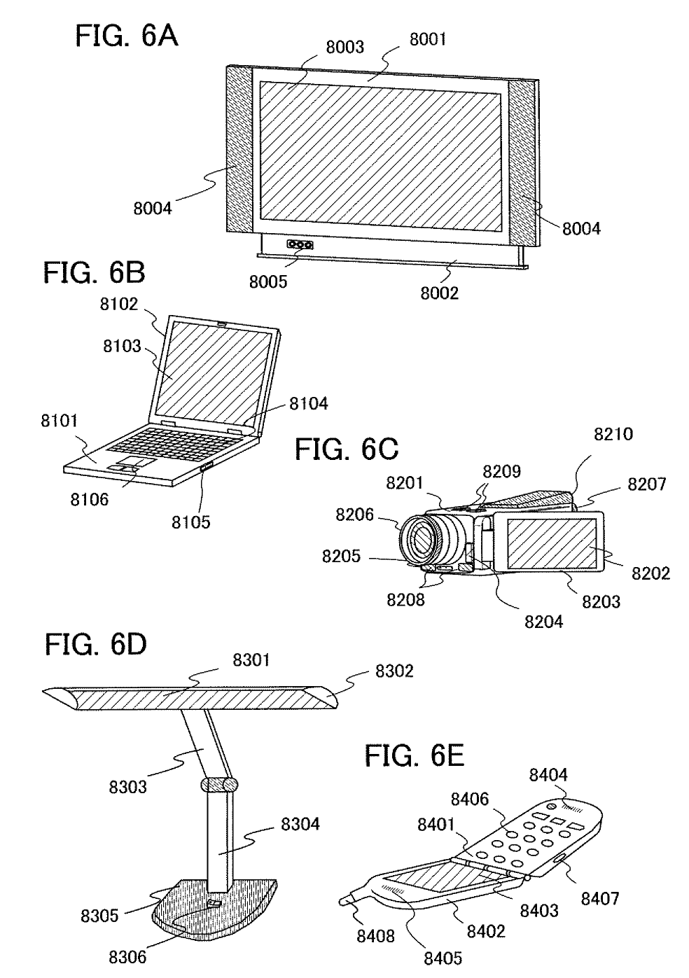

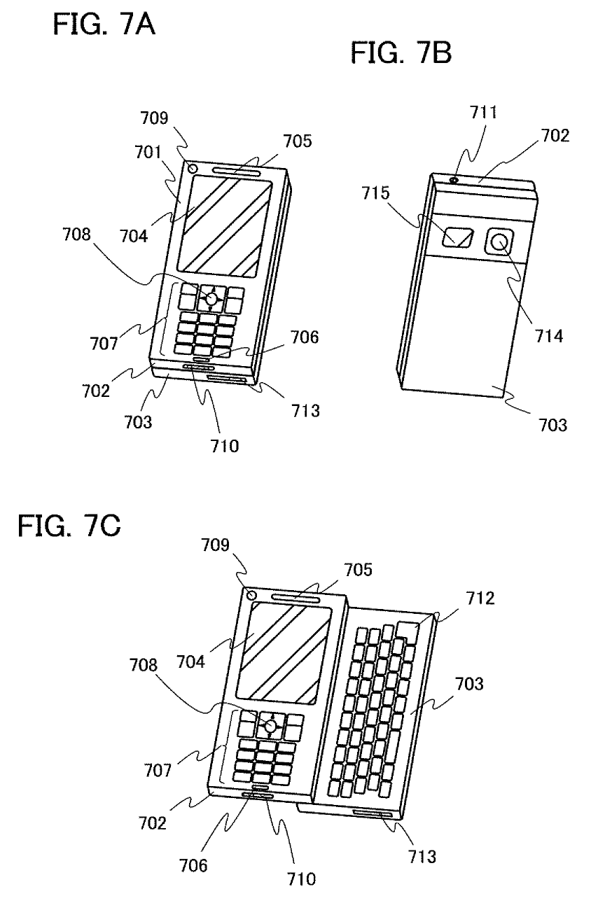

Examples of electronic devices manufactured using the light emitting device include televisions, cameras such as video cameras or digital cameras, goggle type displays (head mounted displays), navigation systems, audio reproducing devices (such as a car audio and an audio component), notebook computers, game machines portable information terminals (such as a mobile computer, a cellular phone, a portable game machine, and an electronic book reader), image reproducing devices provided with recording media (specifically, a device for reproducing a recording medium such as a digital video disc (DVD) and having a display device for displaying the reproduced image), lighting devices, and the like Specific examples of these electronic devices are illustrated in FIGS. 6A to 6E and FIGS. 7A to 7C.

FIG. 6A illustrates a display device which includes a chassis 8001, a support 8002, a display portion 8003, a speaker portion 8004, a video input terminal 8005, and the like. Here, the display device is manufactured by using the light emitting device for the display portion 8003. Note that the display device includes all devices for displaying information in its category, for example, devices for a personal computer, for receiving TV broadcasting, and for displaying an advertisement. In the display device, a light emitting device formed by using a sulfide light emitting body containing a rare-earth copper oxychalcogenide (MCuOS) which is an inorganic EL blue-light emitting body can display blue with high color purity. In addition, since the sulfide light emitting body hardly changes in chromaticity coordinates of blue due to change in luminance, this display device can stably display images with favorable repeatability.

FIG. 6B illustrates a computer which includes a main body 8101, a chassis 8102, a display portion 8103, a keyboard 8104, an external connecting port 8105, a pointing device 8106, and the like. Note that the computer is manufactured by using the light emitting device for the display portion 8103. In the computer, a light emitting device formed by using a sulfide light emitting body containing a rare-earth copper oxychalcogenide (MCuOS) which is an inorganic EL blue-light emitting body can display blue with high color purity. In addition, since the sulfide light emitting body hardly changes in chromaticity coordinates of blue due to change in luminance, this computer can stably display images with favorable repeatability.

FIG. 6C illustrates a video camera which includes a main body 8201, a display portion 8202, a chassis 8203, an external connecting port 8204, a remote control receiving portion 8205, an image receiving portion 8206, a battery 8207, an audio input portion 8208, an operation key 8209, an eye piece portion 8210, and the like. Note that the video camera is manufactured by using the light emitting device for the display portion 8202. In the video camera, a light emitting device formed by using a sulfide light emitting body containing a rare-earth copper oxychalcogenide (MCuOS) which is an inorganic EL blue-light emitting body can display blue with high color purity. In addition, since the sulfide light emitting body hardly changes in chromaticity coordinates of blue due to change in luminance, this video camera can stably display images with favorable repeatability.

FIG. 6D illustrates a lamp which includes a lighting portion 8301, a shade 8302, an adjustable arm 8303, a support 8304, a base 8305, and a power supply switch 8306. Note that the lamp is manufactured by using the light emitting device for the lighting portion 8301. Note that a lamp includes a ceiling light, a wall light, and the like in its category, in addition to the illustrated desk lamp. In the lamp, a light emitting device formed using a sulfide light emitting body containing a rare-earth copper oxychalcogenide (MCuOS) which is an inorganic EL blue-light emitting body hardly changes in chromaticity coordinates of blue due to change in luminance. Therefore, this lamp can emit light with stable chromaticity.

Here, FIG. 6E illustrates a cellular phone which includes a main body 8401, a chassis 8402, a display portion 8403, an audio input portion 8404, an audio output portion 8405, an operation key 8406, an external connecting port 8407, an antenna 8408, and the like. Note that the cellular phone is manufactured by using the light emitting device for the display portion 8403. In the cellular phone, a light emitting device formed by using a sulfide light emitting body containing a rare-earth copper oxychalcogenide (MCuOS) which is an inorganic EL blue-light emitting body can display blue with high color purity. In addition, since the sulfide light emitting body hardly changes in chromaticity coordinates of blue due to change in luminance, this cellular phone can stably display images with favorable repeatability.

In addition, FIGS. 7A to 7C also illustrate an example of a cellular phone. FIG. 7A is a front view, FIG. 7B is a rear view, and FIG. 7C is a development view. This cellular phone is a so-called smartphone in which a main body 701 has both functions of a phone and a portable information terminal, incorporates a computer, and can process a variety of data processing in addition to voice calls.

The main body 701 has two chassis: a chassis 702 and a chassis 703. The chassis 702 includes a display portion 704, a speaker 705, a microphone 706, operation keys 707, a pointing device 708, a camera lens 709, an external connection terminal 710, an earphone terminal 711, and the like. The chassis 703 includes a keyboard 712, an external memory slot 713, a camera lens 714, a light 715, and the like. In addition, an antenna is incorporated in the chassis 702.

Further, in addition to the above-described structure, the smartphone may incorporate a non-contact IC chip, a small size memory device, or the like.

In the display portion 704, which can incorporate a light emitting device, a display orientation is changed as appropriate according to a usage pattern. Because the camera lens 709 is provided in the same plane as the display portion 704, the smartphone can be used for videophone calls. Further, a still image and a moving image can be taken with the camera lens 714 and the light 715 using the display portion 704 as a viewfinder. The speaker 705 and the microphone 706 can be used for videophone calls, recording and playing sound, etc. without being limited to voice calls.

With the operation keys 707, making and receiving calls, inputting simple information such as e-mails, scrolling the screen, moving the cursor, and the like are possible. Furthermore, the chassis 702 and the chassis 703 which overlap each other (see FIG. 7A) can be slid to expose the chassis 703 as illustrated in FIG. 7C, and can be used as a portable information terminal. At this time, smooth operation can be conducted with the keyboard 712 and the pointing device 708. The external connection terminal 710 can be connected to an AC adaptor and various types of cables such as a USB cable, and charging, data communication with a personal computer, or the like are possible. Furthermore, a large amount of data can be stored and moved by inserting a recording medium into the external memory slot 713.

In addition to the above described functions, the smartphone may have an infrared communication function, a television receiver function, and the like.

Note that the cellular phone described above can be manufactured by using the light emitting device for the display portion 704. In the cellular phone, a light emitting device formed by using a sulfide light emitting body containing a rare-earth copper oxychalcogenide (MCuOS) which is an inorganic EL blue-light emitting body can display blue with high color purity. In addition, since the sulfide light emitting body hardly changes in chromaticity coordinates of blue due to change in luminance, this cellular phone can stably display images with favorable repeatability.

As described above, an electronic device or a lamp can be obtained by using the light emitting device of one aspect of the present invention. The range of application of the light emitting device is very wide and the light emitting device can be applied to electronic devices in various fields.

Note that the structure in Embodiment Mode 4 can be combined with the structure in Embodiment Mode 1 or 2 as appropriate

### Embodiment 1

This embodiment describes a measurement result of characteristics of a dispersion type inorganic EL element which is formed using a ZnS:Ag,Cl containing a rare-earth copper oxychalcogenide (MCuOS) synthesized as an inorganic EL blue-light emitting body.

First, as a raw material of a sulfide light emitting body for manufacturing an inorganic EL blue-light emitting body, 2 g of ZnS:Ag,Cl was put into an alumina crucible. To the alumina crucible were added 0.2 g of zinc oxide (ZnO) which is an additive and 0.04 g of a lanthanum copper oxychalcogenide (LaOCuS) which is a rare-earth copper oxychalcogenide (MCuOS). They were baked in a nitrogen atmosphere at 750° C. for four hours to obtain a powder of ZnS:Ag,Cl containing a lanthanum copper oxychalcogenide (LaOCuS). Note that the baking can be conducted in air or vacuum.

Then, the powder of ZnS:Ag,Cl containing a lanthanum copper oxychalcogenide (LaOCuS) was washed. Here, zinc oxide (ZnO) was removed through hydrochloric acid (HCl) cleaning, and excess copper (Cu) on the surface of ZnS:Ag,Cl was removed through chelate cleaning. As described thus far, a ZnS:Ag,Cl containing a lanthanum copper oxychalcogenide (LaOCuS) which is an inorganic EL blue-light emitting body was obtained.

Then, an inorganic EL element was manufactured by using a ZnS:Ag,Cl containing a lanthanum copper oxychalcogenide (LaOCuS) for an inorganic EL layer. In this embodiment, the inorganic EL element has the structure described in Embodiment Mode 2 with reference to FIG. 213, that is, a structure in which a first electrode, an inorganic EL layer, a dielectric layer, and a second electrode are stacked in that order over a substrate.

Note that the first electrode over the substrate was formed of indium tin oxide (ITO) with a thickness of 110 nm, and the inorganic EL layer was formed with a thickness of 20 μm using ZnS:Ag,Cl dispersed at 75% in a binder of a cyanoresin dissolved in N,N-dimethylformamide (DMF). In addition, the dielectric layer was formed with a thickness of 10 μm by applying 10 g of barium titanate and 2.5 g of a cyanoresin which were dissolved in 15 g of N,N-dimethylformamide (DMF). Further, the second electrode was formed using silver (Ag) with a thickness of 50 μm.

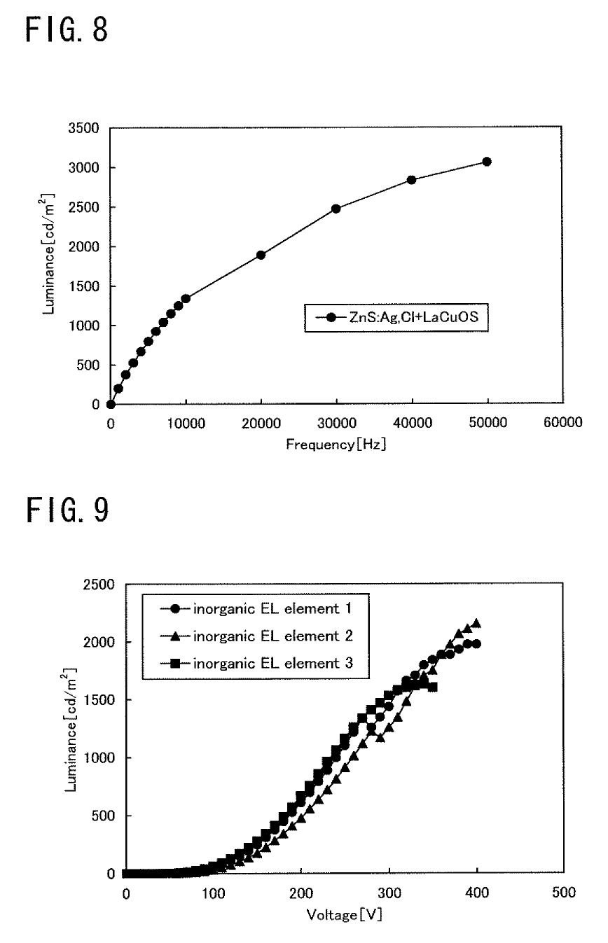

Frequency-luminance characteristics of thus formed inorganic EL element 1 are shown in FIG. 8. As measurement conditions, 400 V of alternating voltage was applied to the inorganic EL element 1, and frequency was made to change in the range of 0 Hz to 50000 Hz. In such conditions, emission luminance of the inorganic EL element 1 was measured. In FIG. 8, the vertical axis indicates emission luminance (cd/m²), and the horizontal axis indicates frequency (Hz). As a result, it is found that the maximum luminance of 3059 cd/m² was exhibited when the frequency was 50 kHz by the inorganic EL element 1 of this embodiment which uses ZnS:Ag,Cl containing a lanthanum copper oxychalcogenide (LaOCuS) (ZnS:Ag,Cl+LaOCuS) which was an inorganic EL blue-light emitting body for the inorganic EL layer. Therefore, it is found that the inorganic EL element 1 can provide sufficient luminance as an inorganic EL light emitting element.

Further, voltage-luminance characteristics of the inorganic EL element 1 are shown in FIG. 9. As measurement conditions, 50 kHz of frequency was applied to the inorganic EL element 1, and alternating voltage was made to change in the range of 0 V to 400 V. In such conditions, emission luminance of the inorganic EL element 1 was measured. In FIG. 9, the vertical axis indicates emission luminance (ed/m²), and the horizontal axis indicates voltage (V).

Furthermore, an inorganic EL element 2 was formed using ZnS:Ag,Cl containing a lanthanum copper oxychalcogenide (LaOCuS) (ZnS:Ag,Cl+LaOCuS) in which magnesium oxide (MgO) was used as an additive in synthesis. The result of the same measurement on the inorganic EL element 2 is shown in FIG. 9. In addition, an inorganic EL element 3 was formed using ZnS:Ag,Cl containing a lanthanum copper oxychalcogenide (LaOCuS) (ZnS:Ag,Cl+LaOCuS) to which an additive was not added in synthesis. The result of the same measurement on the inorganic EL element 3 is shown in FIG. 9.

From the result, it is found that emission luminance higher than 1500 cd/m² can be provided by any of the inorganic EL elements of this embodiment (the inorganic EL element 1, the inorganic EL element 2, and the inorganic EL element 3) which use ZnS:Ag,Cl containing a lanthanum copper oxychalcogenide (LaOCuS) (ZnS:Ag,Cl+LaOCuS) which is an inorganic EL blue-light emitting body for the inorganic EL layers.

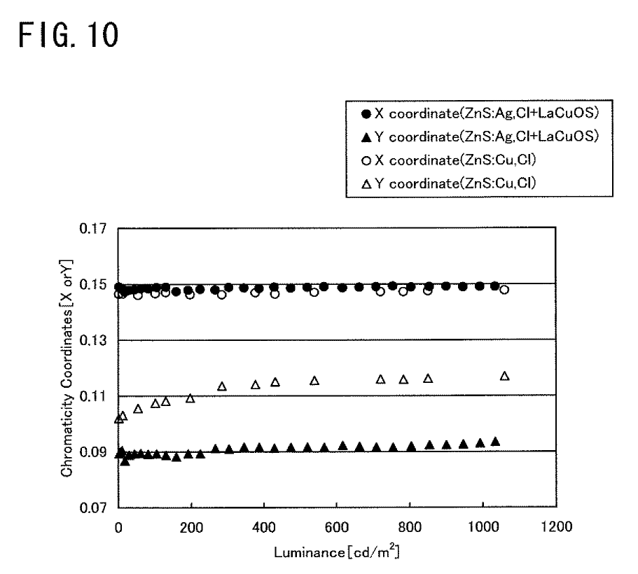

Further, emission luminance-chromaticity coordinate characteristics of the inorganic EL element 1 are shown in FIG. 10. As measurement conditions, by applying alternating voltage which was made to change to the inorganic EL element 1 with 10 kHz of frequency, the emission luminance of the inorganic EL element 1 was made to change in the range of 1 cd/m² to 1000 cd/m². In such conditions, chromaticity coordinates of the inorganic EL element I was measured. In FIG. 10, the vertical axis indicates chromaticity coordinates (the x-coordinate and the y-coordinate) and the horizontal axis indicates emission luminance (cd/m²). Note that on the vertical axis in FIG. 10, which indicates chromaticity coordinates, black circles and black triangles indicate the x-coordinate and the y-coordinate of the inorganic EL element 1, respectively.

Meanwhile, as a comparative element, an inorganic EL element which has an element structure similar to the inorganic EL element 1 and uses Osram Sylvania Type 813 (manufactured by Osram Sylvania, Inc.), which is known as a light emitting body for inorganic EL, for the inorganic EL layer instead of the inorganic EL blue-light emitting body was formed. A measurement result of the emission luminance-chromaticity coordinates characteristics of the comparative element are also shown in FIG. 10. Note that on the vertical axis in FIG. 10, which indicates chromaticity coordinates, white circles and white triangles indicate the x-coordinate and the y-coordinate of the comparative element, respectively.

Note that from the result in FIG. 10, the inorganic EL element 1, which uses ZnS:Ag,Cl containing a rare-earth copper oxychalcogenide (MOCuS) which is an inorganic EL blue-light emitting body, has the maximum value of the x-coordinate of 0.149 and the minimum value of the x-coordinate of 0.147, and the maximum value of the y-coordinate of 0.094 and the minimum value of the y-coordinate of 0.087 as the emission luminance changes. Therefore, it is found that change in x-coordinate (Δₓ) and change in y-coordinate (Δ_{y}) which occur due to change in emission luminance are 0.002 and 0.007, respectively. In contrast the comparative element, which uses Osram Sylvania Type 813 (manufactured by Osram Sylvania, Inc.), has the maximum value of the x-coordinate of 0.148 and the minimum value of the x-coordinate of 0.146, and the maximum value of the y-coordinate of 0.117 and the minimum value of the y-coordinate of 0.102 as the emission luminance changes. Therefore, it is found that change in x-coordinate (Δₓ) and change in y-coordinate (Δ_{y}) which occur due to change in emission luminance are 0.002 and 0.015, respectively.

That is, it is found that in the inorganic EL element 1, which uses a ZnS:Ag,Cl containing a rare-earth copper oxychalcogenide (MCuOS) which is an inorganic EL blue-light emitting body, change in y-coordinate (Δ_{y}) of the chromaticity coordinates, which greatly influences an emission color of blue light emission, due to emission luminance change is smaller than a comparative element.

As described thus far, it is found that an inorganic EL element which uses a ZnS:Ag,Cl containing a rare-earth copper oxychalcogenide (MCuOS) which is an inorganic EL blue-light emitting body is an element which exhibits blue light emission with high color purity without being effected by emission luminance change.

This application is based on Japanese Patent Application serial no. 2008-039823 filed with Japan Patent Office on Feb. 21, 2008, the entire contents of which are hereby incorporated by reference.

What is claimed is:

1. A method for manufacturing an inorganic EL blue-light emitting body comprising:
mixing a sulfide light emitting body and a rare-earth copper oxychalcogenide (MCuOS, wherein M is a rare-earth metal) to obtain a mixture; and
baking the mixture at 600° C. or more and 1000° C. or less to make a sulfide light emitting body containing the rare-earth copper oxychalcogenide (MCuOS).

2. The method for manufacturing an inorganic EL blue-light emitting body according to claim 1,
wherein the sulfide light emitting body is any one of ZnS:Ag,Cl, ZnS:Au,Cl, CdS:Ag,Cl, CdS:Au,Cl, CaS:Ag,Cl, or CaS:Au,Cl.

3. The method for manufacturing an inorganic EL blue-light emitting body according to claim 1,
wherein the rare-earth copper oxychalcogenide (MCuOS) is any one of a lanthanum copper oxychalcogenide (LaCuOS), a cerium copper oxychalcogenide (CeCuOS), a scandium copper oxychalcogenide (ScCuOS), or a yttrium copper oxychalcogenide (YCuOS).

4. The method for manufacturing an inorganic EL blue-light emitting body according to claim 1,
wherein a concentration of the rare-earth copper oxychalcogenide (MCuOS) which is added is 1 wt % or more and 5 wt % or less with respect to the sulfide light emitting body.

5. A method for manufacturing an inorganic EL blue-light emitting body comprising:
mixing a sulfide light emitting body, an additive, and a rare-earth copper oxychalcogenide (MCuOS, wherein M is a rare-earth metal) to obtain a mixture; and
baking the mixture at 600° C. or more and 1000° C. or less to make a sulfide light emitting body containing the rare-earth copper oxychalcogenide (MCuOS).

6. The method for manufacturing an inorganic EL blue-light emitting body according to claim 5,
wherein the sulfide light emitting body is any one of ZnS:Ag,Cl, ZnS:Au,Cl, CdS:Ag,Cl, CdS:Au,Cl, CaS:Ag,Cl, or CaS:Au,Cl.

7. The method for manufacturing an inorganic EL blue-light emitting body according to claim 5,
wherein the rare-earth copper oxychalcogenide (MCuOS) is any one of a lanthanum copper oxychalcogenide (LaCuOS), a cerium copper oxychalcogenide (CeCuOS), a scandium copper oxychalcogenide (ScCuOS), or a yttrium copper oxychalcogenide (YCuOS).

8. The method for manufacturing an inorganic EL blue-light emitting body according to claim 5,
wherein a concentration of the rare-earth copper oxychalcogenide (MCuOS) which is added is 1 wt % or more and 5 wt % or less with respect to the sulfide light emitting body.

9. The method for manufacturing an inorganic EL blue-light emitting body according to claim 5,
wherein the additive is a metal oxide which is soluble in an acid solution.

10. The method for manufacturing an inorganic EL blue-light emitting body according to claim 5,
wherein the additive is any one of zinc oxide (ZnO), magnesium oxide (MgO), or lanthanum oxide (La₂O₃).

11. The method for manufacturing an inorganic EL blue-light emitting body according to claim 5,
wherein a concentration of the additive which is added is 0.1 wt % or more and 20 wt % or less with respect to the sulfide light emitting body.

12. An inorganic EL blue-light emitting body comprising a sulfide light emitting body represented by a formula ZnS:Ag,Cl containing a rare-earth copper oxychalcogenide (MCuOS, wherein M is a rare-earth metal).

13. The inorganic EL blue-light emitting body according to claim 12,
wherein the sulfide light emitting body has an emission peak in a region between a wavelength of 400 nm or more and 500 nm or less.

14. A light emitting element comprising:
an inorganic EL layer between a pair of electrodes; and
a dielectric layer between one of the pair of electrodes and the inorganic EL layer,
wherein the inorganic EL layer includes an inorganic EL blue-light emitting body comprising a sulfide light emitting body represented by a formula ZnS:Ag,Cl containing a rare-earth copper oxychalcogenide (MCuOS, wherein M is a rare-earth metal).

15. A light emitting device comprising:
an inorganic EL layer between a pair of electrodes; and
a dielectric layer between one of the pair of electrodes and the inorganic EL layer,
wherein the inorganic EL layer includes an inorganic EL blue-light emitting body comprising a sulfide light emitting body represented by a formula ZnS:Ag,Cl containing a rare-earth copper oxychalcogenide (MCuOS, wherein M is a rare-earth metal).

16. An electronic device comprising:
an inorganic EL layer between a pair of electrodes; and
a dielectric layer between one of the pair of electrodes and the inorganic EL layer,
wherein the inorganic EL layer includes an inorganic EL blue-light emitting body comprising a sulfide light emitting body represented by a formula ZnS:Ag,Cl containing a rare-earth copper oxychalcogenide (MCuOS, wherein M is a rare-earth metal).
